(19) United States
(12) Patent Application Publication
(10) Pub. No.: US 2009/0121197 A1
(43) Pub. Date: May 14, 2009

(54) Sintered Material, Sinterable Powder Mixture, Method for Producing Said Material and Use Thereof

(75) Inventors: Hubert Thaler, Kempten (DE); Clemens Schmalzried, Pfronten (DE); Frank Wallmeier, Kempten (DE); Georg Victor, Kempten (DE)

Correspondence Address: THE NATH LAW GROUP, 112 South West Street, Alexandria, VA, 22314, US

(73) Assignee: ESK ERAMICS GmbH & KG, Kempten (DE)

(21) Appl. No.: 12/225,426

(22) PCT Filed: Mar. 12, 2007
(86) PCT No.: PCT/EP2007/002159

§ 371 Date: Nov. 24, 2008

(30) Foreign Application Priority Data
Mar. 24, 2006 (DE) 10 2006 013 729.9

(51) Int. Cl. C04B 35/52; C04B 35/56; C04B 35/58; B28B 1/00; H01B 1/04; C25C 3/06

(52) U.S. Cl. 252/516; 501/92; 501/87; 501/96.3; 264/603; 264/434; 264/682; 205/372; 264/645

(57) ABSTRACT

The invention relates to a sintered material which is based on transition metal diborides and comprises
a) as main phase, 90-99% by weight of a fine-grained transition metal diboride or transition metal diboride mixed crystal comprising at least two transition metal diborides or mixtures of such diboride mixed crystals or mixtures of such diboride mixed crystals with one or more transition metal diborides, where the transition metals are selected from sub-groups IV to VI of the Periodic Table,
b) as second phase, 1-5% by weight of particulate boron carbide and/or silicon carbide and
c) optionally as third phase, up to 5% by weight of a non-continuous, oxygen-containing grain boundary phase.
   The invention further relates to a pulverulent sinterable mixture for producing such a sintered material, processes for producing the sintered material, preferably by pressureless sintering, and also to the use of the sintered material as corrosion protection material for salt and metal melts, in particular cryolite-containing melts.

### FIELD OF THE INVENTION

The invention relates to a sintered material based on transition metal diborides, pulverulent sinterable mixtures for producing such a sintered material, processes for producing such sintered materials and the use of the sintered material as corrosion protection material for salt and metal melts, in particular cryolite-containing melts, for producing thermocouple protective tubes for cryolite-containing melts, as electrode protection material, electrode material or material for lining the cells in melt electrolysis for producing Al, and also as electrode material for sliding contacts, welding electrodes and eroding pins.

### BACKGROUND OF THE INVENTION

Titanium diboride has a number of advantageous properties such as a high melting point of 3225° C., a high hardness of 26-32 GPa [HV], excellent electrical conductivity at room temperature and good chemical resistance.

A major disadvantage of titanium diboride is its poor sinterability. The poor sinterability is partly attributable to impurities, in particular oxygen impurities in the form of TiO₂ which are present in the titanium diboride powders usually used as a result of the method of production, either by carbothermic reduction of titanium oxide and boron oxide or by the reduction of the metal oxides by means of carbon and/or boron carbide, known as the boron carbide process. Such oxygen impurities increase grain and pore growth during the sintering process by increasing surface diffusion.

### PRIOR ART

Sintered titanium diboride materials can be produced by the hot pressing process. For example, densities of over 95% of the theoretical density have been achieved by uniaxial hot pressing at sintering temperatures above 1800° C. and a pressure of >20 MPa, with the hot-pressed material typically having a grain size of more than 20 μm. However, the hot pressing process has the disadvantage that only simple body geometries can be produced thereby, while bodies or components having complex geometries cannot be produced by this process.

In contrast, components having more complex geometries can be produced by the pressureless sintering process. Here, it is necessary to add suitable sintering aids in order to obtain sintered bodies having a high density. Possible sintering additives are, for example, metals such as iron and iron alloys. Addition of small amounts of iron makes it possible to obtain dense materials having good mechanical properties and high fracture toughness's of over 8 MPa m^{1/2}. Such materials are described, for example, in EP 433 856 B1. However, these materials have the disadvantage that they have poor corrosion resistance because of the metallic binder phase and are, in particular, not resistant to cryolite and cryolite-containing melts.

EP 0 073 743 B1 describes titanium diboride materials which are corrosion-resistant to aluminum melts and are produced by a pressureless sintering process using titanium hydride and boron as densifying additives. Since these additives obviously do not have grain-growth-inhibiting effects, very large grains are formed at the sintering temperatures of up to 2200° C. employed, resulting in reduced strength and increased microcrack formation due to grain sizes above the critical grain size.

It is known in the technical field that the grain boundaries of sintered titanium diboride materials are the weak points in respect, of the corrosion resistance to cryolite because of liquid-phase infiltration along the grain boundaries.

U.S. Pat. No. 4,500,643 indicates that a sintered material composed of pure, fine-grained titanium diboride is resistant to the use conditions of melt electrolysis for producing Al and thus also to cryolite, but that even small amounts of impurities, in particular oxides or metals, lead to dramatic grain boundary corrosion and thus to disintegration of the component. The titanium diboride material described in this US patent has a porosity of from 10 to 45% by volume and the pores are connected to one another so that continuous porosity through the material is present. Owing to the open porosity, this material is unsuitable for the separation of various media despite its resistance to cryolite; in particular, it is not suitable as corrosion protection material for cryolite. The material is therefore, for example, also not suitable for the production of thermocouple protective tubes for melt electrolysis for producing Al and can also not be used as anode protection material in melt electrolysis for producing Al. Owing to the high porosity, the material also has unsatisfactory mechanical strength.

### OBJECT OF THE INVENTION

It is therefore an object of the invention to provide a sintered material which not only has good mechanical properties but is also corrosion-resistant to salt and metal melts, in particular cryolite-containing melts. Furthermore, the material should have a closed porosity so that it is effective as corrosion protection. Such a sintered material should also be able to be produced by a simple and inexpensive process which also allows the manufacture of shaped bodies having complex geometries.

### SUMMARY OF THE INVENTION

The above object is achieved according to the invention by a sintered material based on transition metal diborides as claimed in claim 1, a pulverulent sinterable mixture for producing such a sintered material as claimed in claim 9, processes for producing such a sintered material as claimed in claims 17 and 18 and the use of the sintered material as claimed in claims 24-27. Advantageous or particularly useful embodiments of the subject matter of the application are described in the dependent claims.

The invention accordingly provides a sintered material which is based on transition metal diborides and comprises
a) as main phase, 90-99% by weight of a fine-grained transition metal diboride or transition metal diboride mixed crystal comprising at least two transition metal diborides or mixtures of such diboride mixed crystals or mixtures of such diboride mixed crystals with one or more transition metal diborides, where the transition metals are selected from sub-groups IV to VI of the Periodic Table,
b) as second phase, 1-5% by weight of particulate boron carbide and/or silicon carbide and
c) optionally as third phase, up to 5% by weight of a non-continuous, oxygen-containing grain boundary phase.

The invention further provides a pulverulent sinterable mixture for producing a sintered material based on transition metal diborides, which comprises
1) 0.05-2% by weight of Al and/or Si as metallic Al and/or Si and/or an amount of an Al and/or Si compound corresponding to this content,
2) optionally at least one component selected from among carbides and borides of transition metals of sub-groups IV to VI of the Periodic Table,
3) 0.5-12% by weight of boron,
4) 0-5% by weight of boron carbide and/or silicon carbide,
5) 0-5% by weight of carbon and/or a carbon compound, in each case based on the content of elemental carbon, and
6) as balance, at least one transition metal diboride of sub-groups IV to VI of the Periodic Table which is different from the transition metal boride of component 2) above.

The invention further provides a process for producing such a sintered material by hot pressing or hot isostatic pressing or gas pressure sintering or spark plasma sintering of a pulverulent mixture as described above, optionally with addition of organic binders and pressing aids.

The invention likewise provides a process for producing a sintered material as described above by pressureless sintering, which comprises the steps:
a) mixing of a pulverulent mixture as described above, optionally with addition of organic binders and pressing aids, with water and/or organic solvents to produce a homogeneous powder suspension,
b) production of a granulated powder from the powder suspension,
c) pressing of the granulated powder to form green bodies having a high density and
d) pressureless sintering of the resulting green bodies under reduced pressure or under protective gas at a temperature of 1800-2200° C.

The sintered material of the invention is suitable as corrosion protection material for salt and metal melts, in particular cryolite-containing melts.

The invention therefore also provides, in particular, the use of the sintered material for producing thermocouple protective tubes for cryolite-containing melts.

The sintered material of the invention is likewise suitable as electrode protection material, electrode material or material for the lining of cells in melt electrolysis for producing Al and also as electrode material for sliding contacts, welding electrodes and eroding pins.

According to the invention, it has thus been shown that the abovementioned object is achieved by provision of a sintered, dense material which is based on transition metal diborides and whose matrix (main phase) comprises a fine-grained transition metal diboride or transition metal diboride mixed crystal or a combination thereof. As second phase, the material contains particulate boron carbide and/or silicon carbide which acts as grain growth inhibitor. If appropriate, the material can contain an oxygen-containing, noncontinuous grain boundary phase as third phase. The mixed crystal formation of the main phase has an additional grain-growth-inhibiting effect, so that a sintered material having good mechanical properties is obtained. Residual contents of impurities, for example oxygen-containing impurities, can be present in particulate form between the grain boundaries or at the triple points of the grain boundaries. The sintered material of the invention has a surprisingly outstanding corrosion resistance to salt and metal melts including cryolite-containing melts.

### DETAILED DESCRIPTION OF THE INVENTION

As mentioned above, the microstructure of the material of the invention comprises the fine-grained main phase comprising a transition metal diboride or transition metal diboride mixed crystal of at least two transition metal diborides or mixtures of such diboride mixed crystals or mixtures of such diboride mixed crystals with one or more transition metal diborides. A smaller proportion of particulate boron carbide and/or silicon carbide, which is located predominantly at the grain boundaries, is present as second phase. The boron carbide and/or silicon carbide additionally have/has a particle-strengthening effect. Furthermore, an oxygen-containing third phase can be present in a small amount at the triple points of the material. Here, it is important that the oxygen-containing phase does not form a continuous grain boundary film. If appropriate, small amounts of particulate carbon and/or particulate boron can also be present in the material. Furthermore, when Al or Si or compounds thereof are used as sintering aids, small amounts of these elements can be present in the main phase. If the oxygen-containing third phase is present, its proportion is preferably up to 2.5% by weight.

The main phase preferably has an average grain size of less than 20 μm, more preferably less than 10 μm. The boron carbide and/or silicon carbide of the second phase preferably has an average particle size of less than 20 μm, more preferably less than 5 μm. The average grain size of the main phase and the average particle size of the boron carbide and/or silicon carbide are determined by the linear intercept length method on an etched polished section.

The transition metals of sub-groups IV to VI are preferably selected from among Ti, Zr, Hf, V, Nb, Ta, Cr, Mo and W.

The main phase is preferably fine-grained TiB₂ and/or ZrB₂ and/or a mixed crystal of (TiW)B₂ and/or (Zr,W)B₂ and/or (Ti,Zr)B₂, more preferably a mixed crystal of (Ti,W)B₂ and/or (Zr,W)B₂, including the ternary diborides (Ti,Zr,W)B₂. The main phase is particularly preferably the mixed crystal (Ti,W)B₂ or the mixed crystal (Zr,W)B₂. The proportion of WB₂ in the main phase is preferably not more than 7% by weight.

The pulverulent, sinterable mixture of the invention for producing a sinterable material according to the invention comprises the following components:

1) 0.05-2% by weight, preferably 0.2-0.6% by weight, of Al and/or Si as metallic Al and/or Si and/or an amount of an Al and/or Si compound corresponding to this content. Preference is given to using Al or oxygen-containing Al compounds, in particular Al₂O₃ or boehmite.
2) Optionally, preferably ≧0.25% by weight of at least one component selected from among carbides and borides of transition metals of sub-groups IV to VI of the Periodic Table, preferably tungsten carbide. If appropriate, transition metals of sub-groups IV to VI themselves and oxides of such transition metals can also be used as component 2). If transition metal carbides are used, their proportion can be up to 15% by weight.
3) 0.5-12% by weight, preferably 1-5% by weight, of boron in elemental form.
4) 0-5% by weight of boron carbide and/or silicon carbide.
5) 0-5% by weight, preferably 0.1-1% by weight, of carbon and/or a carbon compound as organic carbon carrier, in each case based on the content of elemental carbon. The carbon added serves to reduce the oxides present as impurities in the starting materials or the oxides formed during sintering. Examples of suitable carbon compounds are dispersed carbon black, phenolic resins and sugar.
6) As balance, at least one transition metal diboride of sub-groups IV to VI of the Periodic Table which is different from the transition metal boride of component 2) above. As mentioned above, the transition metals are selected from among Ti, Zr, Hf, V, Nb, Ta, Cr, Mo and W. The transition metal diboride of component 6) is preferably TiB₂ and/or ZrB₂, more preferably TiB₂.

The above components of the pulverulent mixture are preferably used in a very high purity and a small particle size. For example, the transition metal diboride of component 6) preferably has an average particle size of not more than 4 μm, more preferably not more than 2 μm.

The sintered material of the invention can be produced in a manner known per se by hot pressing, hot isostatic pressing, gas pressure sintering or spark plasma sintering of a pulverulent mixture as described above, if appropriate with addition of organic binders and pressing aids. Here, it is possible to use customary organic binders such as polyvinyl alcohol (PVA), water-soluble resins and polyacrylic acids and also customary pressing aids such as fatty acids and waxes.

To produce the sintered material of the invention, at least one transition metal diboride of sub-groups IV to VI is processed together with other pulverulent components and, if appropriate, organic binders and pressing aids in water and/or organic solvents to form a homogeneous powder suspension. The homogeneous powder suspension is then converted into a granulated powder, preferably by spray drying. This granulated powder can then be processed further by hot pressing or hot isostatic pressing or gas pressure sintering to give a sintered material.

In a preferred embodiment, the sintered material of the invention is produced by pressureless sintering. Here, a granulated powder obtained as described above is pressed to form green bodies having a high density. All customary shaping processes such as uniaxial pressing or cold isostatic pressing and also extrusion, injection molding, slip casting and pressure slip casting can be used for this purpose. The green bodies obtained are then converted into a sintered material by pressureless sintering under reduced pressure or under protective gas at a temperature of 1800-2200° C., preferably 1900-2100° C., more preferably about 2000° C.

The green bodies are preferably baked in an inert atmosphere at temperatures below the sintering temperature in order to remove the organic binders or pressing aids before pressureless sintering.

The materials obtained by pressureless sintering have a density of at least about 94% of the theoretical density, preferably a density of at least 97% of the theoretical density. Such density values ensure that any porosity present is closed porosity. If desired, the sintered material can be after-densified by hot isostatic pressing to increase the density and to reduce the closed porosity.

The component of the pulverulent starting mixture which is selected from among carbides of transition metals of sub-groups IV to VI of the Periodic Table reacts with the added boron during the sintering process to form transition metal boride and boron carbide. The transition metal boride formed and/or the added transition metal boride of the abovementioned component 2) can form a mixed crystal with the transition metal diboride of component 6), for instance titanium diboride. This boride mixed crystal formation has a grain-growth-inhibiting effect. The boron carbide, both that added and that formed, for example, from tungsten carbide and boron, likewise has a grain-growth-inhibiting effect. In the production of the sintered materials of the invention, it is important that the oxygen impurities present in the powder mixture react very completely so as to prevent the formation of continuous, oxygen-containing grain boundary films. This is achieved by reduction by means of boron and the added carbon and/or carbon compounds and also by evaporation under reduced pressure. At relatively high temperatures, volatile oxides can preferably be removed in the temperature range from 1600 to 1700° C.

The amounts of the added boron and the added carbon and/or carbon compounds in the starting mixture are calculated so that the reduction reactions (1) to (3) shown below proceed to completion:

WC+6 B→WB₂+B₄C (1)

TiO₂+4 B→TiB₂+2 BO(g) (2)

2 B₂O₃+7C→B₄C+6 CO (3)

In the above reduction reaction (1), WC was chosen by way of example as representative of the above-mentioned component 2).

The Al and/or Si or their compounds act as sintering aids and the microstructure formed indicates a liquid-phase sintering process.

The cryolite-resistant and dense, fine-grained material of the invention is suitable for wear applications. The sintered material of the invention is also outstandingly suitable as corrosion protection material for salt and metal melts, e.g. Al and Cu melts, in particular cryolite-containing melts. Specific uses of the sintered material of the invention are thermocouple protective tubes for cryolite-containing melts, electrode protection materials, electrode materials or materials for lining the cells in melt electrolysis for producing Al and also as electrode materials for sliding contacts, welding electrodes and eroding pins.

### BRIEF DESCRIPTION OF THE ACCOMPANYING DRAWINGS

FIG. 1 shows an optical photomicrograph of the microstructure of the material obtained in Example 1;

FIG. 2 shows an optical photomicrograph of the microstructure of FIG. 1 after the cryolite test;

FIG. 3 shows an optical photomicrograph of the microstructure of the sintered material obtained in Example 2;

FIG. 4 shows an optical photomicrograph of the microstructure of FIG. 3 after the cryolite test;

FIG. 5 shows an optical photomicrograph of the microstructure of the sintered material obtained in reference Example 1;

FIG. 6 shows an optical photomicrograph of the microstructure of FIG. 5 after the cryolite test;

FIG. 7 shows an optical photomicrograph of the microstructure of the sintered material obtained in reference Example 2;

FIG. 8 shows an optical photomicrograph of the microstructure of FIG. 7 after the cryolite test;

FIG. 9 shows an optical photomicrograph of the microstructure of the sintered material obtained in reference Example 3;

FIG. 10 shows an optical photomicrograph of the microstructure of FIG. 9 after the cryolite test;

FIG. 11 shows a bright-field transmission electron micrograph of a representative region of the microstructure of FIG. 1; and

FIG. 12 shows a bright-field transmission electron micrograph (at left) perpendicular to the grain boundary of the microstructure of FIG. 11 and also the associated one-dimensional spectrum (at right) along the white line shown in the left-hand image.

The following examples and reference examples illustrate the invention. To assess the cryolite resistance, the following test was carried out.

### Cryolite Test

The sample is heated together with an amount of pure cryolite which completely covers the material in a closed carbon crucible and maintained at 1000° C. for 24 hours. The surface is subsequently assessed by microscopy.

### EXAMPLE 1

450 g of TiB₂ powder (d50=2 μm; 1.7% by weight of oxygen, 0.15% by weight of carbon, 0.077% by weight of iron), 30 g of tungsten carbide (d50<1 μm), 10 g of amorphous boron (purity: 96.4%, d50<1 μm), 8 g of B₄C (d50=0.7 μm) and 2 g of aluminum oxide (boehmite as starting material) are dispersed together with 10 g of polyvinyl alcohol having an average molar mass of 1500 as binder, 20 g of stearic acid as pressing aid and 20 g of commercial sugar in aqueous solution and spray dried. The granular spray-dried material is cold-isostatically pressed at 1200 bar to give green bodies. The green bodies are heated under reduced pressure to 2020° C. at a heating rate of 10 K/min and maintained at the sintering temperature for 45 minutes. Cooling is carried out under Ar with the heating power switched off.

The density of the sintered bodies obtained is 98% of the theoretical density.

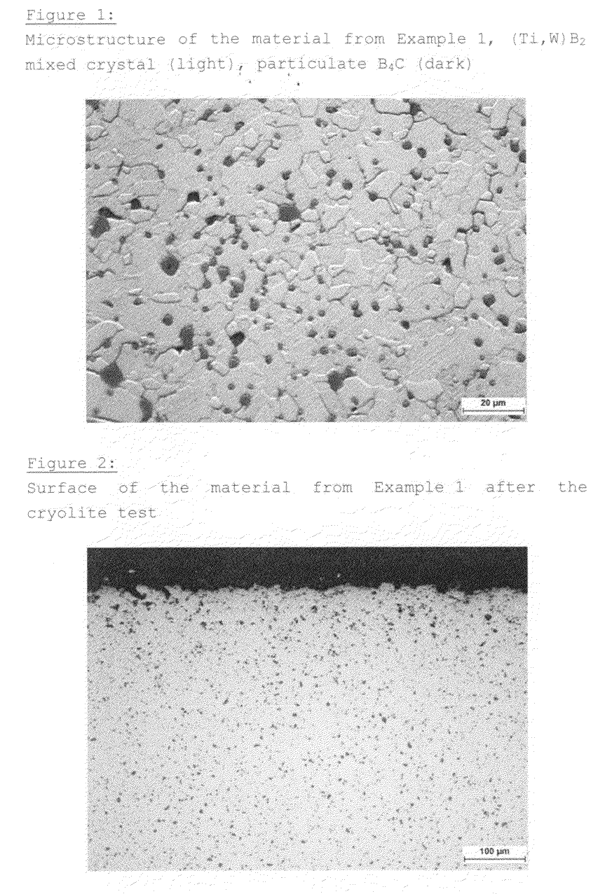

An optical photomicrograph of the microstructure is shown in FIG. 1.

The resulting microstructure comprises a (Ti,W)B₂ mixed crystal matrix, particulate B₄C and particulate boron (see transmission electron micrographs in FIG. 11).

The TEM studies carried out on this specimen shown that the grain boundaries are free of oxygen and other impurities. In addition, small amounts of aluminum are present in the (Ti,W)B₂ mixed crystal.

The EDX spectrum recorded over the total section of FIG. 11 shows only the elements Ti, W, B and Al. No oxygen is found.

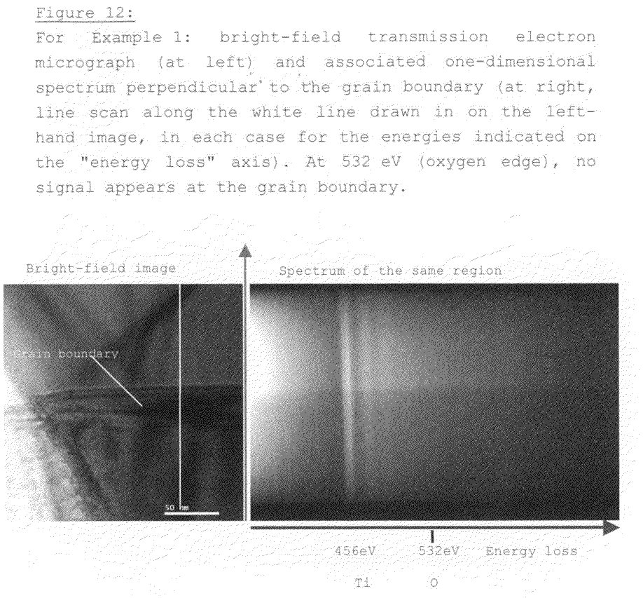

The grain boundaries were also examined using the high-resolution spectrum imaging method in the TEM. The line scan over the grain boundary as a function of the electron loss energy (FIG. 12) shows neither an oxygen signal (532 eV) at the grain boundary nor a shift in the Ti signal (456 eV) which would occur if a Ti-containing secondary phase were present.

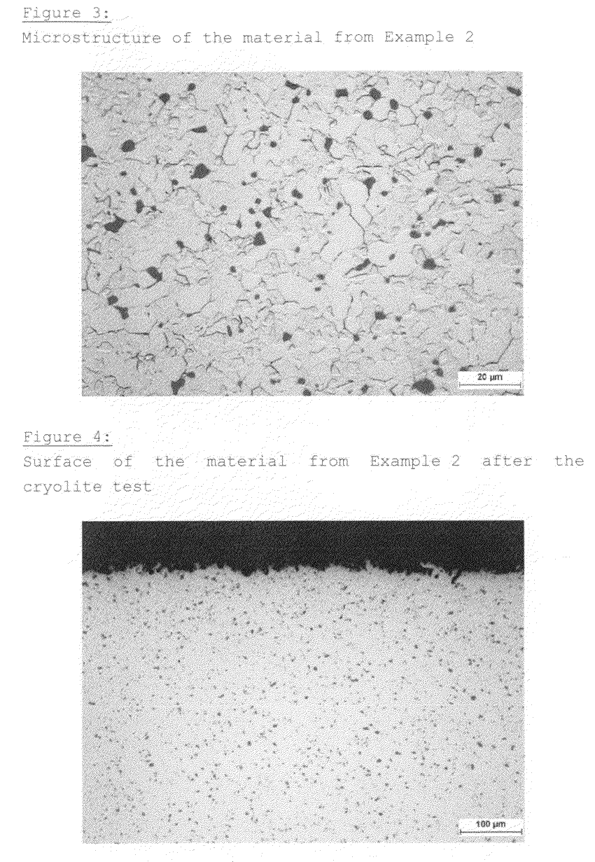

A specimen having dimensions of 10×10×10 mm³ is subsequently subjected to a cryolite test in which it is exposed to a cryolite melt for 24 hours at 1000° C. The subsequent examination of the microstructure of the specimen shows that the grain boundaries are stable to attack by cryolite (see FIG. 2).

### EXAMPLE 2

450 g of TiB₂ powder (d50=2 μm; 1.7% by weight of oxygen, 0.15% by weight of carbon, 0.077% by weight of iron), 30 g of tungsten carbide (d50<1 μm), 10 g of amorphous boron (purity: 96.4%, d50<1 μm), 8 g of B₄C (d50=0.7 μm) and 2 g of aluminum oxide (boehmite as starting material) are dispersed together with 10 g of polyvinyl alcohol having an average molar mass of 1500 as binder and 20 g of stearic acid as pressing aid in aqueous solution and spray dried. The granular spray-dried material is cold-isostatically pressed at 1200 bar to give green bodies. The green bodies are heated under reduced pressure to 1650° C. at a heating rate of 10 K/min, the hold time at 1650° C. is 45 minutes and the green bodies are subsequently heated to 2020° C. at 10 K/min and maintained at the sintering temperature for 45 minutes. Cooling is carried out under Ar with the heating power switched off.

The density of the sintered bodies obtained is 97.8% of the theoretical density.

An optical photomicrograph of the microstructure is shown in FIG. 3.

The resulting microstructure comprises a (Ti,W)B₂ mixed crystal matrix, particulate B₄C and particulate boron.

Oxidic impurities in the grain boundary are removed by evaporation and reduction of the oxides during the additional heat treatment step at 1650° C.

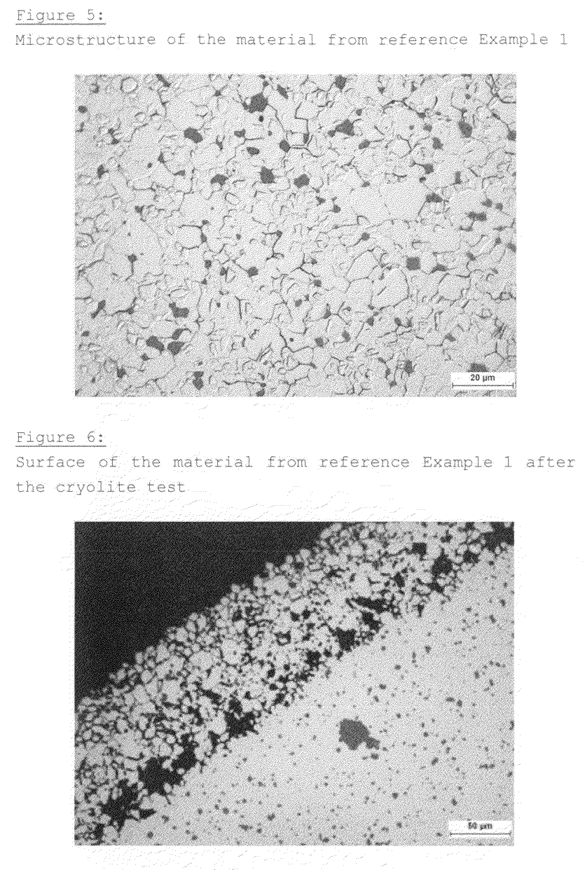

The corrosion test in cryolite (24 h at 1000° C.) shows no penetration via the grain boundaries (FIG. 4).

### REFERENCE EXAMPLE 1

450 g of TiB₂ powder (d50=2 μm; 1.7% by weight of oxygen, 0.15% by weight of carbon, 0.077% by weight of iron), 30 g of tungsten carbide (d50<1 μm), 10 g of amorphous boron (purity: 96.4%, d50<1 μm), 8 g of B₄C (d50=0.7 μm) and 2 g of aluminum oxide (boehmite as starting material) are dispersed together with 10 g of polyvinyl alcohol having an average molar mass of 1500 as binder and 20 g of stearic acid as pressing aid in aqueous solution and spray dried. The granular spray-dried material is cold-isostatically pressed at 1200 bar to give green bodies. The green bodies are heated under reduced pressure to 2020° C. at a heating rate of 10 K/min and maintained at the sintering temperature for 45 minutes. Cooling is carried out under Ar with the heating power switched off.

The density of the sintered bodies obtained is 97.9% of the theoretical density.

An optical photomicrograph of the microstructure is shown in FIG. 5.

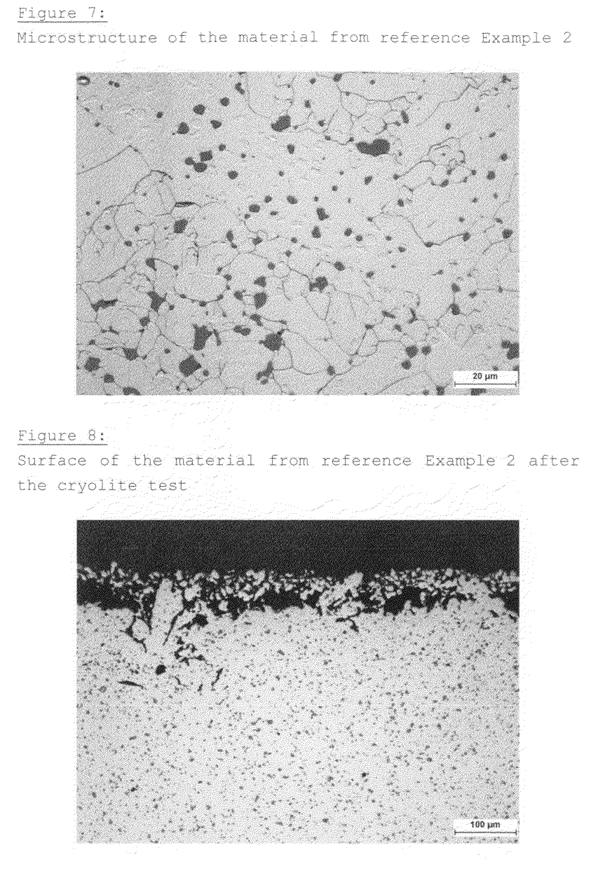

The resulting microstructure comprises a (Ti,W)B₂ mixed crystal matrix, particulate B₄C, a particulate Ti—Al—B—O phase and a continuous amorphous oxygen-containing grain boundary film. Owing to the formation of a continuous oxygen-containing grain boundary film having a thickness of about 2 nm, the material displays grain boundary penetration by a cryolite melt at 1000° C. Massive disintegration of the material occurs because of the grain boundary corrosion (FIG. 6).

### REFERENCE EXAMPLE 2

450 g of TiB₂ powder (d50=2 μm; 1.7% by weight of oxygen, 0.15% by weight of carbon, 0.077% by weight of iron), 30 g of tungsten carbide (d50<1 μm), 15 g of amorphous boron (purity: 96.4%, d50<1 μm), 10 g of B₄C (d50=0.7 μm) and 2 g of aluminum oxide (boehmite as starting material) are dispersed together with 10 g of polyvinyl alcohol having an average molar mass of 1500 as binder and 20 g of stearic acid as pressing aid in aqueous solution and spray dried. The granular spray-dried material is cold-isostatically pressed at 1200 bar to give green bodies. The green bodies are heated under reduced pressure to 2020° C. at 10 K/min and maintained at the sintering temperature for 45 minutes. Cooling is carried out under Ar with the heating power switched off.

The density of the sintered bodies obtained is 96.9% of the theoretical density.

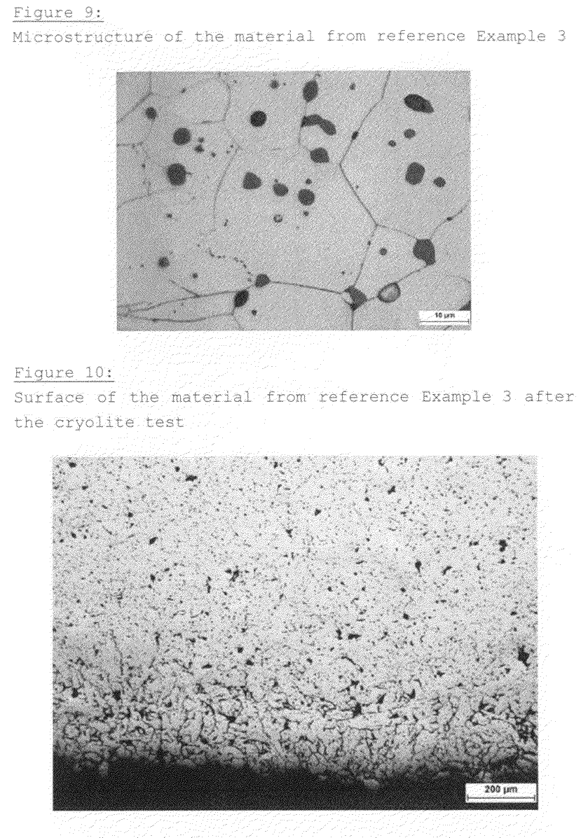

An optical photomicrograph of the microstructure is shown in FIG. 7.

Compared to Examples 1 and 2, corrosion via the grain boundary on contact with a cryolite melt is observed (FIG. 8); grain boundary precipitates which are not cryolite-stable are formed.

### EXAMPLE 3

### Production of a Thermocouple Protective Tube

The granular spray-dried material from Example 1 (bulk density: 1.12 g/cm³, residual moisture content: 0.4%, d50=51 μm) is cold-isostatically pressed to produce a hollow tube which is closed at one end and has the dimensions 764 mm length and 31.5 mm diameter. The sintering cycle is the same as in Example 1. The longitudinal shrinkage is 16.9% and the transverse shrinkage is 20.6%. The sintered density is 98% of the theoretical density. The sintered tube is after-densified by hot isostatic pressing at 2000° C. and 1950 bar. The density after after-densification is 99.3% of the theoretical density.

### REFERENCE EXAMPLE 3

### Starting Mixture without Al Compound as Sintering Aid

450 g of TiB₂ powder (d50=2 μm; 1.7% by weight of O, 0.15% by weight of C, 0.077% by weight of Fe), 30 g of WC (d50<1 μm) and 20 g of amorphous B (purity: 96.4%, d50<1 μm) are dispersed together with 10 g of polyvinyl alcohol having an average molar mass of 1500 as binder and 20 g of stearic acid as pressing aid in aqueous solution and spray dried. The granular spray-dried material is cold-isostatically pressed at 1200 bar to form green bodies. The green bodies are heated under reduced pressure to 2170° C. at 10 K/min and maintained at the sintering temperature for 45 minutes. Cooling is carried out under Ar with the heating power switched off. The sintered body is subsequently after-densified at 2000° C. under an Ar pressure of 1950 bar for one hour. The density is 97.9% of theoretical density.

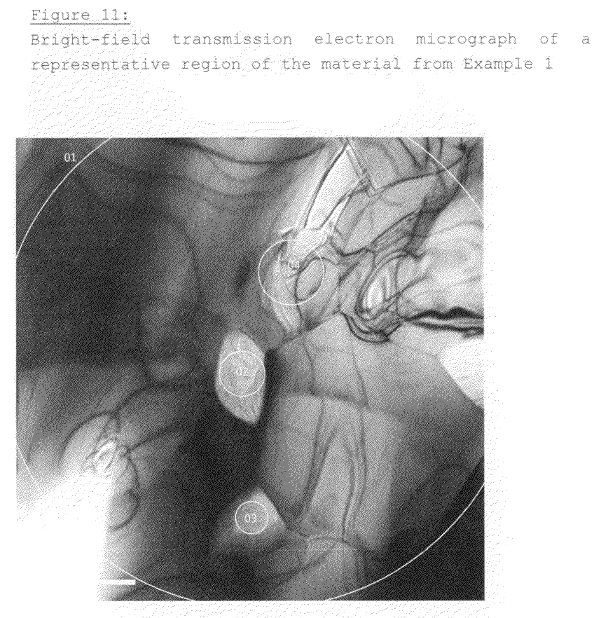

An optical photomicrograph of the microstructure is shown in FIG. 9.

The resulting microstructure comprises a (Ti,W)B₂ mixed crystal matrix and particulate boron carbide which is partly present in the grain boundary and partly in the mixed crystal grains. The average grain diameter is about 100 μm.

A higher sintering temperature was required here to achieve densification. A coarse-grain microstructure results.

This material, too, was subjected to a cryolite test. Compared to Examples 1 and 2, corrosion via the grain boundary on contact with a cryolite melt is observed (FIG. 10). The material is not cryolite-resistant.

1. A sintered material which is based on transition metal diborides and comprises
a. as main phase, 90-99% by weight of a fine-grained transition metal diboride or transition metal diboride mixed crystal comprising at least two transition metal diborides or mixtures of such diboride mixed crystals or mixtures of such diboride mixed crystals with one or more transition metal diborides, where the transition metals are selected from sub-groups IV to VI of the Periodic Table,
b. as second phase, 1-5% by weight of particulate boron carbide and/or silicon carbide and
c. optionally as third phase, up to 5% by weight of a non-continuous, oxygen-containing grain boundary phase.

2. The material as claimed in claim 1, wherein the main phase a) has an average grain size of less than 20 μm, preferably less than 10 μm.

3. The material as claimed in claim 1, wherein the boron carbide and/or silicon carbide of the second phase b) have/has an average particle size of less than 20 μm, preferably less than 5 μm.

4. The material as claimed in claim 1, wherein the proportion of the second phase b) is 1-4% by weight.

5. The material as claimed in claim 1, wherein the third phase c) is present in a proportion of up to 2.5% by weight.

6. The material as claimed in claim 1, wherein the transition metals of sub-groups IV to VI are selected from among Ti, Zr, Hf, V, Nb, Ta, Cr, Mo and W.

7. The material as claimed in claim 1, wherein the main phase a) is fine-grained TiB₂ and/or ZrB₂ and/or a mixed crystal of (TiW)B₂ and/or (Zr,W)B₂ and/or (Ti,Zr)B₂, preferably a mixed crystal of (Ti,W)B₂ and/or (Zr,W)B₂, more preferably the mixed crystal (Ti,W)B₂ or the mixed crystal (Zr,W)B₂.

8. The material as claimed in claim 1, wherein the proportion of WB₂ in the main phase a) is ≦7% by weight.

9. A pulverulent sinterable mixture for producing a sintered material based on transition metal diborides, which comprises
1. 0.05-2% by weight of Al and/or Si as metallic Al and/or Si and/or an amount of an Al and/or Si compound corresponding to this content,
2. optionally at least one component selected from among carbides and borides of transition metals of sub-groups IV to VI of the Periodic Table,
3. 0.5-12% by weight of boron,
4. 0-5% by weight of boron carbide and/or silicon carbide,
5. 0-5% by weight of carbon and/or a carbon compound, in each case based on the content of elemental carbon, and
6. as balance, at least one transition metal diboride of sub-groups IV to VI of the Periodic Table which is different from the transition metal boride of component 2) above.

10. The mixture as claimed in claim 9, wherein the proportion of component 1) is 0.2-0.6% by weight.

11. The mixture as claimed in claim 9, wherein the proportion of component 2) is ≧0.25% by weight.

12. The mixture as claimed in claim 9, wherein the transition metal diboride of the component 6) has an average particle size of ≦4 μm, preferably ≦2 μm.

13. The mixture as claimed in claim 9, wherein the transition metals of sub-groups IV to VI are selected from among Ti, Zr, Hf, V, Nb, Ta, Cr, Mo and W.

14. The mixture as claimed in claim 9, wherein component 2) is tungsten carbide.

15. The mixture as claimed in claim 9, wherein the transition metal diboride of component 6) is TiB₂ and/or ZrB₂.

16. The mixture as claimed in claim 9, wherein the proportion of component 5) is 0.1-1% by weight.

17. A process for producing a sintered material as claimed in claim 1 by hot pressing or hot isostatic pressing or gas pressure sintering or spark plasma sintering of a pulverulent mixture as claimed in at least one of claims 9-16, optionally with addition of organic binders and pressing aids.

18. A process for producing a sintered material as claimed in claim 1 by pressureless sintering, which comprises the steps:
a. mixing of a pulverulent mixture as claimed in at least one of claims 9-16, optionally with addition of organic binders and pressing aids, with water and/or organic solvents to produce a homogeneous powder suspension,
b. production of a granulated powder from the powder suspension,
c. pressing of the granulated powder to form green bodies having a high density and
d. pressureless sintering of the resulting green bodies under reduced pressure or under protective gas at a temperature of 1800-2200° C.

19. The process as claimed in claim 18, wherein the production of the granulated powder in step b) is carried out by spray drying.

20. The process as claimed in claim 18, wherein the production of the green bodies in step c) is carried out by uniaxial pressing, cold isostatic pressing, extrusion, injection molding, slip casting or pressure slip casting.

21. The process as claimed in claim 18, wherein the green bodies obtained in step c) are baked in an inert atmosphere at temperatures below the sintering temperature before pressureless sintering.

22. The process as claimed in claim 18, wherein the pressureless sintering in step d) is carried out at a temperature in the range 1900-2100° C., preferably about 2000° C.

23. The process as claimed in claim 18, wherein the material which has been produced by pressureless sintering is after-densified by hot isostatic pressing.

24. The use of the sintered material as claimed in claim 1 as corrosion protection material for salt and metal melts, in particular cryolite-containing melts.

25. The use of the sintered material as claimed in claim 1 for producing thermocouple protective tubes, in particular for cryolite-containing melts.

26. The use of the sintered material as claimed in claim 1 as electrode protection material, electrode material or material for lining the cells in melt electrolysis for producing Al.

27. The use of the sintered material as claimed in claim 1 as electrode material for sliding contacts, welding electrodes and eroding pins.
